(19) United States
(12) Patent Application Publication
(10) Pub. No.: US 2010/0153581 A1
(43) Pub. Date: Jun. 17, 2010

(54) METHOD AND SYSTEM FOR OPTIMIZING NETWORK TRANSMISSION OF RENDERED DOCUMENTS

(75) Inventors: Ramesh Nagarajan, Pittsford, NY (US); Zhigang Fan, Webster, NY (US); Vishal Monga, Webster, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 12/337,183

(22) Filed: Dec. 17, 2008

(51) Int. Cl. G06F 17/30; G06F 15/16

(52) U.S. Cl. 709/238; 707/E17.032

(57) ABSTRACT

A method and system for optimizing network transmission of print documents to a rendering device. A document for rendering (e.g., print job) can be received and metadata related to the document analyzed simultaneously. The metadata can then be compared to a number of locally saved files and the document containing matching metadata can be rendered directly from a local storage device, thereby reducing network traffic. Otherwise, the document can be transferred over a network to the rendering device. A record of a number of times the document is being requested for rendering can be tracked by the rendering device in order to retain the document for an extended period of time.

### TECHNICAL FIELD

Embodiments are generally related to data-processing systems and methods. Embodiments are also related to rendering devices such as printers, scanners, multi-function devices, photocopy machines, and the like. In addition, embodiments relate to methods and systems for optimizing the network transmission of rendered documents.

### BACKGROUND OF THE INVENTION

Network printing systems generally include an assemblage of varying rendering devices, client computers, servers, and other components that are connected to and communicate over a network. Rendering devices include components such as printers, scanners, faxes, copy machines, and so forth. One particular type of rendering device is a MFD (Multi-Function Device). Multi-function devices such as, for example, printers and copiers, provide users with the ability to output a print processing job utilizing a wide variety of features (e.g., print speed, print quality, paper size, paper source, copy count, orientation, color, grayscale, stapling, duplexing, sorting, etc.).

The rendering job can be assembled at the client computer and transmitted over the network to the server linked to a variety of rendering devices. The rendering job generally includes one or more electronically stored files and print attributes which inform the printer how to process the files. In general, a number of files can be typically transferred over the network while printing. Also, there are some large customer environments where the same document is rendered over and over again in multiple locations.

In many enterprise environments, for example, which are concentrated around sales, administrators often find the same documents (e.g., a recent memo from a senior management, a recent change to sales collateral, a new product announcement, etc.), being rendered multiple times by different users. The majority of prior art approaches do not possess the capability of identifying such repeated documents that have been previously sent by a user. Hence, the same documents can be rendered over and over again in multiple locations, which affect network traffic and efficiency. Such prior art techniques are also time consuming, especially when the volume of data is large, which can result in an increased burden imposed on a memory device such as, for example, a disk, which in turn delays scheduling and can render the overall processing time much longer.

Based on the foregoing, it is believed that a need, therefore, exists for an improved method and system for optimizing network transmission of rendered documents (e.g., printed documents), as described in greater deal herein. A need also exists for identifying the repeated requests for rendering the same document content from multiple users in a network in order to avoid increased network traffic in large customer environments.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for an improved method and system for configuring rendering devices such as printers, scanners, multi-function devices, photocopy machines, and the like.

It is yet a further aspect of the present invention to provide for an improved method and system for optimizing the network transmission of rendered documents.

The aforementioned aspects and other objectives and advantages can now be achieved as described herein. A method and system for optimizing network transmission of rendered documents to a multi-function device is disclosed. A document for rendering (e.g., print job) can be received and metadata related to the document can be analyzed simultaneously. The metadata can then be compared to a number of locally saved files and the document that contains matching metadata can be rendered directly from a local storage device, thereby reducing network traffic. Otherwise, the document can be transferred over a network to a multi-function device or other appropriate rendering device. A record of the number of times the document is being requested for rendering can be tracked by the multi-function device in order to retain the document for an extended period of time. The document metadata utilized for comparison includes, for example, data such as the last modified date and time stamps, file name, file size, keywords, a random check of ‘M’ bytes in the file, etc.

Additionally, a document submitted more than a particular number of times to the rendering device can be automatically routed to other rendering devices in the network during off work hours. Also, the threshold utilized to trigger automatic routing and time preferences for such transfers can be configured by a system administrator. The disclosed approach can be employed to automatically identify documents already transmitted to the rendering device and render such documents from the local storage device in order to reduce network traffic. Such an approach generates faster rendering productivity for customers and seamless integration of network multi-function devices and/or other types of rendering devices.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a multi-function device (MFD), which can be implemented in accordance with a preferred embodiment;

FIG. 2 illustrates a block diagram of a network printing system, which can be implemented in accordance with a preferred embodiment;

FIG. 3 illustrates a schematic block diagram illustrating various metadata utilized for analyzing a rendering job, which can be implemented in accordance with a preferred embodiment; and

FIG. 4 illustrates a high level flow chart illustrating logical operational steps of a method for optimizing network transmission of print documents in a network printing system, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of such embodiments.

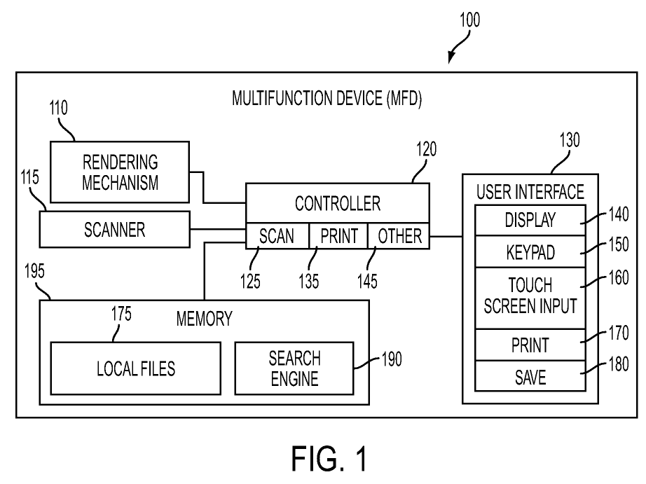

FIG. 1 illustrates a block diagram of a rendering device 100, which can be implemented in accordance with a preferred embodiment. The rendering device 100 can be implemented as an MFD device that includes a scanner 115, a user interface 130, a rendering mechanism 110, a memory 195, and a controller 120. As utilized herein, the rendering device 100 refers to any device(s) that is capable of copying documents, printing computer-generated documents, scanning documents, or faxing documents. Thus, rendering device 100 may be a standalone single function device such as a dedicated printer, scanner, copy machine, etc. Preferably, rendering device 100 functions as an MFD device capable of multiple rendering functions such as printing, copying, scanning, faxing, etc. The rendering mechanism 110 can, for example, constitute any number of well-known printer technologies for rendering pages from local files 175 stored in memory 195. Memory 195 may include, for example, one or more text strings, one or more digital image files, and one or more electronic text files.

Memory 195 can be configured to include computer readable media, store any related software, and may include any combination of volatile or non-volatile memory, such as floppy disks, hard disks, CD-ROMs, flash memory, read-only memory (ROM), and random access memory (RAM). Other memory that can be utilized to store data in the rendering device 100 can include electronic, magnetic, optical, and/or other types of storage media. The controller 120 of the rendering device 100 directs operation of all components and functions of the device 100 and optionally comprises any one of, or all of, scan function 125, rendering function 135, and optical character recognition function 145.

The controller 120 preferably includes hardware, software, firmware or combination of these. In one preferred embodiment, controller 120 includes a microprocessor-based system or other system capable of performing a sequence of logical operation and including memory for storing information. Alternatively, controller 120 can be incorporated into an application specific integrated circuit (ASIC) which can be configured to include hardware, software, and/or firmware for providing scan function 125, print function 135, and “other” functions 145, such as, for example, a fax function copy function, etc. Note that rendering device 100 may constitute, for example, a printer, a copier, fax machine, scanner, and/or other types of rendering components, depending upon design considerations. The user interface 130 of the rendering device 100 can be utilized to access and manage all of the conventional features of the rendering device 100 (such as for example, start printing, stop printing, etc.), as well as for reviewing and managing features of the rendering device 100.

The user interface 130 can be configured in some embodiments to include a keypad 150, a display 140, an optional touch screen input 160, a print option 170, and a save option 180. The keypad 150 permits entry of alphanumeric and/or symbolic characters that can be utilized for searching the user document within the memory 195. The display 140 shows results of use of keypad 150 and the status of functions of the rendering device 100, including a search engine 190. Touch screen input 160 can be optionally provided as part of display 140 to permit operation of functions of rendering device 100 through display 140. A system administrator may configure routing of documents for rendering through the local user interface 130 by manipulating the touch screen 160, keypad 150, or communicating via wireless messages through a wireless port. The administrator's portable device that communicates wirelessly may be a personal digital assistant (PDA), or the like.

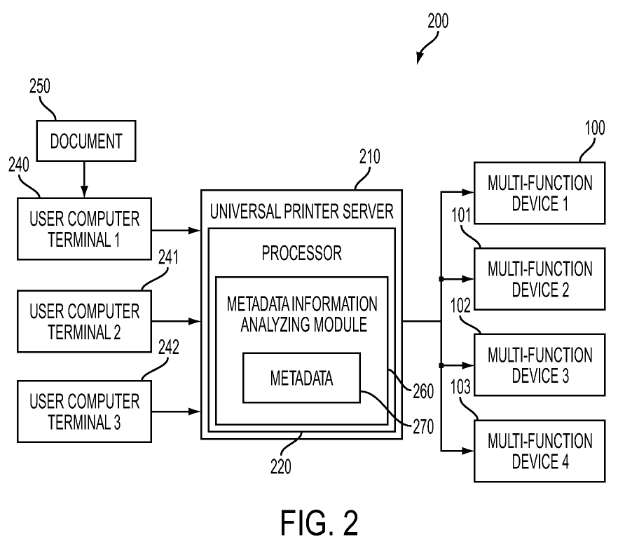

FIGS. 1-2 are provided as exemplary diagrams of rendering device and network printing system in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

FIG. 2 illustrates a block diagram of a network printing system 200, which can be implemented in accordance with a preferred embodiment. Note that in FIGS. 1-4 identical or similar blocks are generally indicated by identical reference numerals. Network printing system 200 can include one or more rendering devices 100, 101, 102, 103, etc, one or more computer terminals 240, 241, 242, and a universal printer server 210 in operative communication with the rendering devices 100 and the computer terminals 240. The universal printer server 210 can act as an operative communication medium between the user computer terminals 240, 241, 242 and the rendering devices 100, 101, 102, 103, etc. In general, the rendering devices 100, 101, 102, and/or 103 can be utilized to perform a rendering output function (e.g., printing, scanning, copying, faxing, etc) within a networked environment. Note that rendering devices 100, 101, 102, and 103 are generally analogous to one another. Similarly, computer terminals 240, 241, and 242 are also similar to one another.

The universal printer server 210 include at least one processor 220 that is capable of executing application software for receiving documents 250 for rendering from the user computer terminals 240 and automatically selecting destination network rendering devices 100 for routing the documents 250 based on metadata. The computer terminals 240, 241, 242, etc., can be, for example, any computing device capable of being integrated within a network, such as a PDA, personal computer, cellular telephone, point-of-sale terminal, server, etc. In some environments, the print server may be embedded within each MFD (Multi-Function Device).

Note that as utilized herein, the term “metadata” generally refers to “data about data”, or of any sort of data contained in any media. An item of metadata may describe an individual datum, or content item, or a collection of data including multiple content items and hierarchical levels, for example, a database schema. In data processing, metadata is definitional data that provides information about or documentation of other data managed within an application or environment. For example, metadata would document data about data elements or attributes (name, size, data type, etc) and data about records or data structures (length, fields, columns, etc) and data about data (where it is located, how it is associated, ownership, etc.). Metadata may include descriptive information about the context, quality and condition, or characteristics of the data. Metadata can be thought of as data used to identify, describe, and locate resources. For instance, subject gateways provide information (metadata) about individual Web sites, typically including the author, the title, the URL (Web address) and a brief description.

The rendering device 100 can be located remotely with respect to each other, or alternatively, they may be located locally with respect to each other such as, for example, at a print shop or in an office environment. The rendering job requests from the user computer terminals 240, 241, and/or 242 can include at least one document 250 and metadata 270 which can set forth user desired printing parameters such as page range, number of copies, finishing requirements, paper quality, paper size, color or gray-scale printing, page setup, fonts etc. The processor 220 can automatically select the destination rendering devices 100, 101, 102, and/or 103 for routing the rendering job requests.

The embodiments described herein can be implemented in the context of a host operating system and one or more modules. Such modules may constitute hardware modules such as, for example, electronic components of a computer system. Such modules may also constitute software modules. In the computer programming arts, a software “module” can be typically implemented as a collection of routines and data structures that performs particular tasks or implements a particular abstract data type.

The processor 220 can be operatively connected to each user computer terminal 240, 241, and/or 242 for receiving the document 250 for rendering and routing the document 250 to at least one of the network printers 100 capable of optimally satisfying the network transmission of documents. The universal printer server 210 further includes a metadata-analyzing module 260 that can be utilized to analyze metadata 270 related to the document 250. The metadata-analyzing module 260 includes a set of programmable instructions capable of being executed by at least one processor 220 for analyzing the metadata 270 of the document 250 received from the user computer terminal 240 and transmitting the document 250 to the one or more of the network rendering devices 100, 101, 102, and/or 103.

The metadata 270 related to the document 250 can be compared to a number of locally saved files 175 and the document 250 that contains matching metadata 270 can be printed directly from the local storage 195, thus reducing network traffic. Otherwise, the document 250 can be transmitted over the network to one or more of the rendering devices 100, 101, 102, and/or 103. A record of the number of times the document 250 is requested for rendering can be tracked by the universal printer server 210 in order to retain the document 250 for an extended period of time. The documents that get submitted more than certain number of times to the rendering devices 100, 101, 102, and/or 103 can be automatically routed to other rendering devices in the network during off work hours.

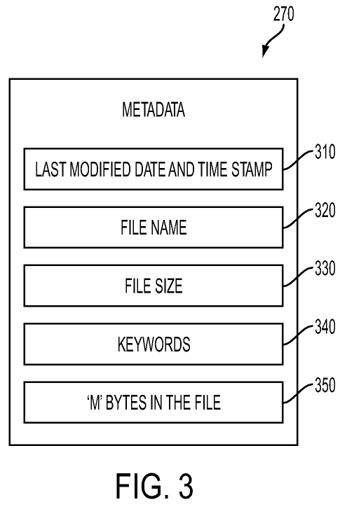

FIG. 3 illustrates a schematic block diagram illustrating metadata 270 utilized for analyzing the rendering job, in accordance with a preferred embodiment. Metadata is data about data. Metadata 270 can be a structured data, which describes the characteristics of the rendering job. The metadata 270 generally includes a number of pre-defined elements representing specific attributes of a resource and each element can have one or more values. The metadata 270 utilized for comparison of documents 250 with locally saved files 175 generally includes last modified date and time stamp 310, file name 320, file size 330, keywords 340, and random check of ‘M’ bytes in the file 350.

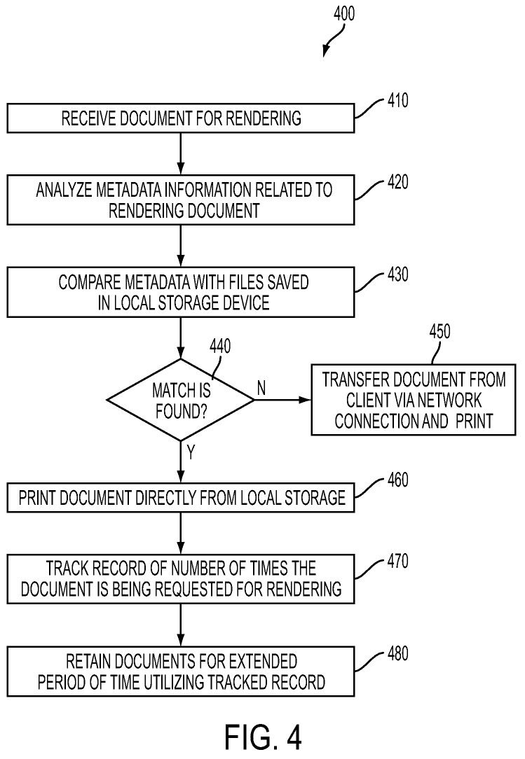

FIG. 4 illustrates a high level flow chart illustrating logical operational steps of a method 400 for optimizing network transmission of print documents in the network rendering system 100, which can be implemented in accordance with a preferred embodiment. Note that the method 400 can be implemented in the context of a computer-useable medium that contains a program product. As illustrated in FIG. 4, the method 400 can be utilized to effectively identify the documents that have been previously sent to the rendering device 100 by analyzing several metadata 270 regarding the document 250 and comparing this information to data contained in locally saved files.

The document 250 for rendering can be received from a computer terminal 240 (or another computing device), as illustrated at block 410. As illustrated at block 420, the metadata 270 related to the document 250 can be analyzed. Further, the analyzed documents can be compared with a number of locally saved files 175 that are stored in the memory 195, as depicted at block 430. A test can then be performed to determine if the metadata 270 of the document 250 matches with the metadata of the locally saved files 175 stored in the memory 195, as illustrated at block 440. If the metadata of the document 250 matches with the locally saved files 175, the document 250 can be printed directly from the local memory 195, as illustrated at block 460.

Otherwise, the document 250 can be transferred from the user computer terminals 240 via the universal rendering server 210 and the document 250 can be rendered via one or more of the rendering devices 100, 101, 102, and/or 103, as illustrated at block 450. A record of a number of times the document is being requested for rendering can be tracked by the universal printer server 210 in order to retain the document 250 for an extended period of time, as depicted at blocks 470 and 480. The method 400 can be effectively implemented in large customer environments where same documents can be requested by different user computer terminals from multiple locations.

Additionally, documents submitted more than a certain number of times to the rendering devices 100, 101, 102, and/or 103 can be automatically routed to other rendering devices in the network during off work hours. Similarly, the threshold utilized to trigger automatic routing and a preferred time for such transfers can be configured by a system administrator. The disclosed approach can be employed to automatically identify documents already sent to the rendering device(s) and rendering such documents from local storage in order to reduce the network traffic. Also, such an approach generates faster rendering productivity for customers and seamless integration of network rendering devices.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for optimizing network transmission of rendered documents, said method comprising:
receiving a document for rendering;
analyzing a plurality of metadata associated with said document in order to determine if said document was previously sent to at least one rendering device; and
comparing said plurality of metadata to a plurality of files stored in a local storage device in order to thereafter route said document directly from said local storage device to at least one rendering device to reduce network traffic if at least one metadata among said plurality of metadata matches data contained within said plurality of files.

2. The method of claim 1 further comprising:
routing said document to at least one networked rendering device via a network connection if said plurality of metadata related to said document is not available in said local storage device.

3. The method of claim 1 further comprising:
tracking a record of a number of times said document is requested for rendering to said at least one rendering device in order to retain said document for an extended period of time.

4. The method of claim 1 further comprising:
determining a maximum number of times said document is submitted; and
automatically routing said document submitted a maximum number of times to other rendering devices in communication with said network connection during a time said network is least used and accessed by users.

5. The method of claim 1 wherein said plurality of metadata comprises at least one of the following types of data:
a last modified date;
a time stamp;
a file name;
a file size;
a plurality of keywords; and
a random check of ‘M’ bytes in said plurality of files.

6. The method of claim 1 further comprising:
configuring a threshold utilized to trigger an automatic routing and a preferred time for said automatic routing by a system administrator.

7. The method of claim 1 further comprising:
automatically purging at least one file among said plurality of files, if said at least one file is accessed by a user.

8. The method of claim 1 further comprising:
configuring a threshold, wherein said threshold is utilized to trigger an automatic purging of said at least one file among said plurality of files by a system administrator

9. The method of claim 1 wherein said rendering device comprises an MFD device.

10. A method for optimizing network transmission of rendered documents, said method comprising:
receiving a document for rendering;
analyzing a plurality of metadata associated with said document in order to determine if said document was previously sent to at least one rendering device;
comparing said plurality of metadata to a plurality of files stored in a local storage device in order to thereafter route said document directly from said local storage device to at least one rendering device to reduce network traffic if at least one metadata among said plurality of metadata matches data contained within said plurality of files;
routing said document to at least one networked rendering device via a network connection if said plurality of metadata related to said document is not available in said local storage device; and
tracking a record of a number of times said document is requested for rendering to said at least one rendering device in order to retain said document for an extended period of time.

11. The method of claim 10 further comprising:
determining a maximum number of times said document is submitted; and
automatically routing said document submitted a maximum number of times to other rendering devices in communication with said network connection during a time said network is least used and accessed by users.

12. A system for optimizing network transmission of rendered documents, said system comprising:
a processor;
a data bus coupled to said processor; and
a computer-usable medium embodying computer code, said computer-usable medium being coupled to said data bus, said computer program code comprising instructions executable by said processor and configured for:
receiving a document for rendering;
analyzing a plurality of metadata associated with said document in order to determine if said document was previously sent to at least one rendering device; and
comparing said plurality of metadata to a plurality of files stored in a local storage device in order to thereafter route said document directly from said local storage device to at least one rendering device to reduce network traffic if at least one metadata among said plurality of metadata matches data contained within said plurality of files.

13. The system of claim 12 wherein said instructions are further configured for routing said document to at least one networked rendering device via a network connection if said plurality of metadata related to said document is not available in said local storage device.

14. The system of claim 12 wherein said instructions are further configured for tracking a record of a number of times said document is requested for rendering to said at least one rendering device in order to retain said document for an extended period of time.

15. The system of claim 12 wherein said instructions are further configured for:
determining a maximum number of times said document is submitted; and
automatically routing said document submitted a maximum number of times to other rendering devices in communication with said network connection during a time said network is least used and accessed by users.

16. The system of claim 12 wherein said plurality of metadata comprises at least one of the following types of data:
a last modified date;
a time stamp;
a file name;
a file size;
a plurality of keywords; and
a random check of ‘M’ bytes in said plurality of files.

17. The system of claim 12 wherein said instructions are further configured for providing a threshold utilized to trigger an automatic routing and a preferred time for said automatic routing by a system administrator.

18. The system of claim 12 wherein said instructions are further configured for automatically purging at least one file among said plurality of files, if said at least one file is accessed by a user.

19. The system of claim 12 wherein said instructions are further configured for configuring a threshold, wherein said threshold is utilized to trigger an automatic purging of said at least one file among said plurality of files by a system administrator

20. The system of claim 12 wherein said rendering device comprises an MFD device.
